(19) United States
(12) Patent Application Publication
(10) Pub. No.: US 2021/0049559 A1
(43) Pub. Date: Feb. 18, 2021

(54) SYSTEM FOR ON DEMAND GEOFENCED WASTE DISPOSAL AND PICKUP

(71) Applicant: Curb It, LLC, Lebanon, OH (US)

(72) Inventor: Tad Kilburn, Lebanon, OH (US)

(21) Appl. No.: 16/991,577

(22) Filed: Aug. 12, 2020

Related U.S. Application Data
(60) Provisional application No. 62/888,033, filed on Aug. 16, 2019.

(51) Int. Cl. G06Q 10/00; G06Q 10/04; G01C 21/34; H04W 4/021

(52) U.S. Cl. CPC G06Q 10/30; G06Q 10/04; H04W 4/021; G01C 21/3461; G01C 21/343

(57) ABSTRACT

A system for providing on demand geofenced waste management is configured to receive requests for waste pickup from a plurality of users spread across a geographic region. Pickup requests describe the location and type of waste, which may include landfill waste, but may also include recyclables, items for donation, and items having particular disposal requirements (e.g., some chemicals and electronics). The system is configured to geo-map requests to particular waste management providers and, once accepted by those providers, produce optimized pickup routes for one or more vehicles associated with the provider. Route optimization may be performed by a process such as a genetic algorithm that receives input such as the number and type of vehicles available, costs associated with operating each vehicle (e.g., cost-per-mile, cost-per-pickup, cost-per-hour), the number of pickups accepted by the field provider over a period of time, and the location and distance between locations of pickups.

### PRIORITY

This application claims priority to U.S. Provisional Application Ser. No. 62/888,033, entitled SYSTEM FOR ON DEMAND GEOFENCED WASTE DISPOSAL AND PICKUP, filed Aug. 16, 2019, the disclosure of which is incorporated by reference herein.

### FIELD

The disclosed technology pertains to a system for on demand waste disposal and pickup.

### BACKGROUND

Waste management can be an inconvenient but necessary task for homeowners and tenants alike. Commonly, a city organization or private company that contracts with a city organization will provide weekly curbside pickup of a limited amount of waste from each address within the city. As an example, this may include bagged waste and other objects that fit within a certain type of trash can or disposal container while still allowing the lid to close. Trash cans of a certain size and type may be required and may be provided by waste disposal service. By controlling the number and size of trash cans that are provided to residents, the waste disposal service can limit the amount of curbside waste that must be picked up on any day.

While such a system provides predictable patterns and responsibilities for waste management providers, it can be very inconvenient for the residents that depend upon it. Residents will typically be required to place their waste at the curb on a specific day each week. Thus, if a resident is sick, busy, or otherwise unable to have the waste at curbside on that day, they may have to wait up to a week for the next opportunity to empty their containers. This schedule can become unpredictable on holidays, leading to further confusion and missed opportunities to empty containers. Waste management providers may also refuse to pick up curbside waste in some scenarios, such where it is not properly bagged or prepared, or where the waste has fallen out of or cannot fit within a container and is placed on the ground. This is often the case with large items such as couches, chairs, and mattresses, which will generally be ignored by providers when picking up waste unless special arrangements have been made. In order to have such items picked up, residents may have an annually limited number of stickers or markers that can be used to mark the items for pickup, or in some cases may have to call the waste management provider and schedule a specially arranged pickup.

Costs related to providing containers, weekly curbside pickup, specially scheduled pickup of large items, and other requirements for large scale waste management are typically passed on to residents through taxes or utility costs that are associated with the property itself. As a result, there is often little or no choice in the level and type of service that is available for residential waste management.

What is needed, therefore, is an improved system for on demand waste disposal and pickup.

### BRIEF DESCRIPTION OF THE DRAWINGS

The drawings and detailed description that follow are intended to be merely illustrative and are not intended to limit the scope of the invention as contemplated by the inventors.

FIG. 1 is a schematic diagram of an exemplary system for providing on demand geofenced waste management;

FIG. 2 is a flowchart of an exemplary set of high-level steps that the system of FIG. 1 could perform to provide on demand waste management to a plurality of residents;

FIG. 3 is a flowchart of an exemplary set of steps that could be performed to request pickup;

FIG. 4 is a flowchart of an exemplary set of steps that could be performed to distribute pickup requests to a plurality of field providers;

FIG. 5 is a flowchart of an exemplary set of steps that could be performed to create optimized pickup routes; and

FIG. 6 is a flowchart of an exemplary set of steps that could be performed to provide route guidance and pickup management.

### DETAILED DESCRIPTION

The inventors have conceived of novel technology that, for the purpose of illustration, is disclosed herein as applied in the context of on demand geofenced waste management. While the disclosed applications of the inventors' technology satisfy a long-felt but unmet need in the art, it should be understood that the inventors' technology is not limited to being implemented in the precise manners set forth herein, but could be implemented in other manners without undue experimentation by those of ordinary skill in the art in light of this disclosure. Accordingly, the examples set forth herein should be understood as being illustrative only, and should not be treated as limiting.

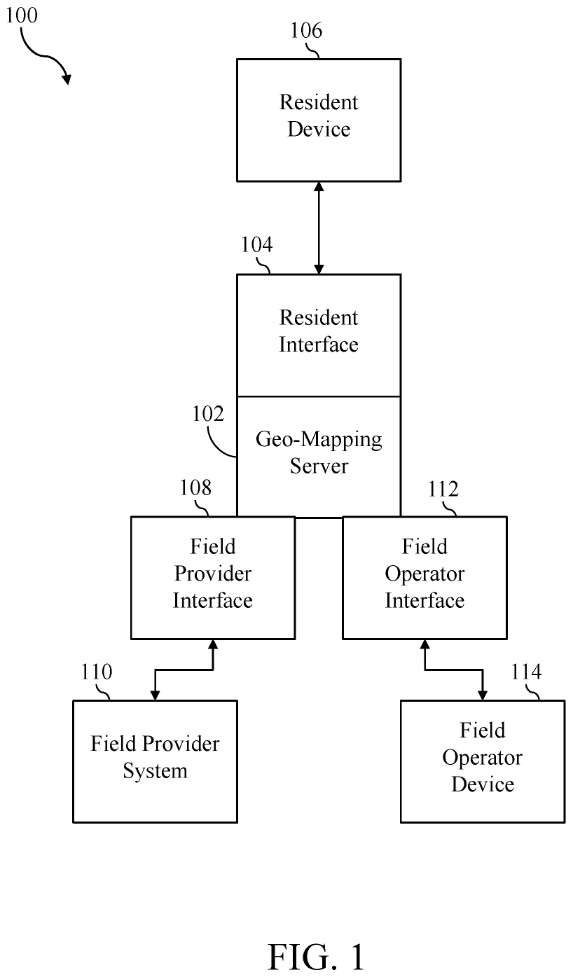

Turning now to the figures, FIG. 1 is a schematic diagram of an exemplary system (100) for providing on demand geofenced waste management. A server (102) is configured to manage the receipt and assignment of waste pickup requests, and to plan and coordinate waste pickup routes. In addition to executing a number of internal processes, the server (102) provides external interfaces and web-services that may be accessed by users of the system (102) in order to interact with the system (102) and, indirectly, with each other. The server (102) may be implemented as one or more physical servers, cloud servers, virtual servers, or other processing environments. The server (102) may include, for example, one or more processors, memories, communication devices, storage devices, and other component as will be apparent to one skilled in the art in light of this disclosure.

As examples of external interfaces provided by the server (102), FIG. 1 shows a resident interface (104), a field provider interface (108), and a field operator interface (112). The interfaces may be used as data communication channels, and may be implemented as, for example, websites, web services, application programming interfaces (“API”), or other software interfaces, and may be accessible through a specific software application (e.g., a desktop application or mobile application configured to communicate with the interface) or more general software applications (e.g., a web browser configured to load a website from the interface). The interfaces are configured to allow users of the system (100) to access and interact with the features of the system (100). The users of the system (100) include residents (e.g., homeowners, tenants, business owners, and others utilizing waste management services), field providers (e.g., public or private organizations that offer waste management services), and field operators (e.g., drivers and other individuals associated with a vehicle that is used for waste pickup).

The resident interface (106) may be exposed by the server (102) and accessible by a plurality of resident devices (106). A resident device (106) may be, for example, a smartphone, a tablet, or another handheld device, may be a laptop or desktop computer, or may be another computing device having features such as a processor, memory, storage device, communication device (e.g., a Wi-Fi or cellular data network transceiver), user interface (e.g., display, keyboard, mouse, touchscreen display), and others. The resident device (106) may be configured with software that interacts with the server (102) to allow the user to request on-demand waste pickup, as will be described in further detail below. As one example, the resident device (106) may be a smartphone or other handheld device that is configured with a mobile application that may be used to submit requests to the server (102) via the resident interface (104).

The field provider interface (108) may be exposed by the server (102) and accessible by a plurality of field provider systems (110) or devices. The field provider system (110) may be device such as a laptop or smartphone configured to communicate with the field provider interface (108) as has been described, or may be a business information system used by the field provider in the ordinary course of business. As one example, the field provider system (110) may be a business computer that accesses the field provider interface (108) via a web browser in order to view a website from which the field provider can view pickup requests, approve pickup requests, and view other information related to the system (100). As another example, where the field provider system (110) is a business information system used by the field provider, it may be configured with custom software applications and settings that exchange information with the field provider interface (108), which may be an API. This may be useful where a field provider wishes to create their own interfaces for using the system (100), or more closely integrate the system (100) and its data with their own business systems.

The field operator interface (112) may be exposed by the server (102) and accessible by a plurality of field operator devices (114). A field operator device (114) may be a smartphone, tablet, laptop, or other handheld device or proprietary computing device that may be associated with and used from a vehicle that is operating within the field to provide waste management services to residents. As one example, the field operator device (114) may be a handheld device that is carried by an occupant of the vehicle or mounted within the cabin of the vehicle, and that is capable of communicating with a cellular data network and accessing the field operator interface (112) while in the field. In such an example, the field operator device (114) may be configured with a mobile application that exchanges data with the server (102) via the field operator interface (112), and that provides and displays information that is usable by the associated field operators to perform and track waste pickups.

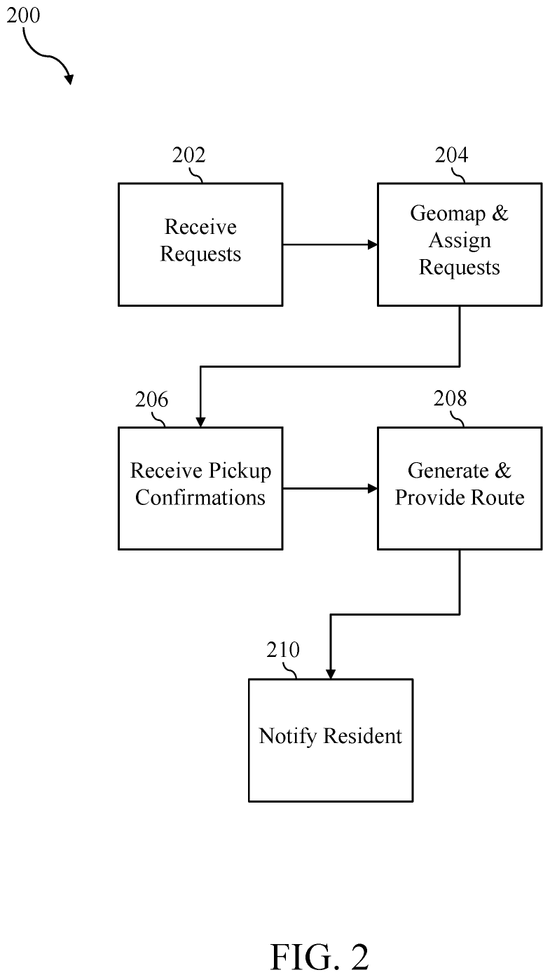

FIG. 2 shows a set of high-level steps (200) that could be performed to provide some of the described features of the system (100). A set of requests for pickup of waste may be received (202) at the server (102) from a number of resident devices (106). Information received by the server (102) with the request may include, for example, a resident, a resident address, a desired date range for the pickup, and a description of items to be picked up. As requests are received (202), or from time to time based on a configured schedule, the server (102) may analyze the requests in order to geo-map and assign (204) the requests to an appropriate field provider. This may include identifying an appropriate field provider based upon the type of waste or items to be picked up and the location of the resident or items.

As requests are mapped and assigned (204) to field providers, the field providers may review and accept the requests with the field provider system, which may be a manual process (e.g., reviewing requests on a website and selecting those that will be serviced) or an automated process (e.g., the field provider system (110) may be configured to receive batch requests via the field provider interface (108) and automatically accept or refuse them based upon vehicle and data describing vehicle and labor availability stored on the field provider system (110)). As the field provider review and accepts requests for waste pickup, the server (102) will receive (206) data that confirms the pickup, and that may also include information such as the estimated date and time of pickup, descriptions of vehicles, field operators, or other requirements for pickup, and other related information.

The server (102) may be configured regularly generate and provide (208) routing information that may be used by field operators to service the pickup requests. Routing provided (208) to the field provider may identify particular vehicles, as well as schedules and routes that correspond to confirmed waste pickups that will be serviced by each vehicle. Routing information may be generated (208) for each field provider based upon confirmations received (206) from that field provider and may also be based on a variety of factors related to the capabilities of the field provider. As an example, factors that may influence generation (208) of routes may include the number and type of vehicles used by the field provider in waste pickup, the availability of labor and employees to operate vehicles, costs associated with operating each vehicle (e.g., cost-per-mile, cost-per-pickup, cost-per-hour), the number of pickups accepted by the field provider over a period of time, and the location and distance between locations of pickups.

As will be described in more detail below, generating (208) routes will include applying optimization processes to balance a number of variables in order to identify a satisfactory solution that is efficient, but in most cases may not be the truly ideal solution. For example, when performed for a particular field provider, generation (208) of routes may distribute several hundred scheduled waste pickups across a fleet of ten vehicles so that an efficiency of 95% is achieved for that distribution, where efficiency is measured by such factors as the minimization of time and distance that each vehicle operates to perform that vehicle's route, the minimization of overall cost associated with operating each vehicle to perform that vehicle's route, or both. While technically possible to achieve 100% efficiency at least in some cases, the cost in processor time and cycles to achieve such a result would frequently exceed any savings in improving a routes efficiency from 95% to 100%, and may also require hours or days of processing time which may delay the pickup of waste. In some implementations, the server (102) may be configured to generate (208) routing one or more times each day for every field provider that is using the system, which means that balancing the efficiency of routing and the efficiency of generating (208) routes is important. In some implementations, the system may optimize routes based on a variety of factors for specific requests that are to be managed and fulfilled, including route optimization based on geographic proximity and load capacity planning based on proprietary allocated load scales that are developed and assigned depending on the specific item being requested by a resident or user. This may advantageously allow equipment assignments for fulfillment based on capacity and load sizes, while still ensuring route optimization is in place.

As routes are generated (208) and performed, the server (102) may be configured to notify (210) residents by providing information associated with their pickup request. Such information may include indicating when the pickup request is confirmed by a field provider, the day and approximate time of pickup based upon the generated (208) route, and a more accurate day and time of pickup based upon information from the field operator device (114) as the route is being executed by a field operator.

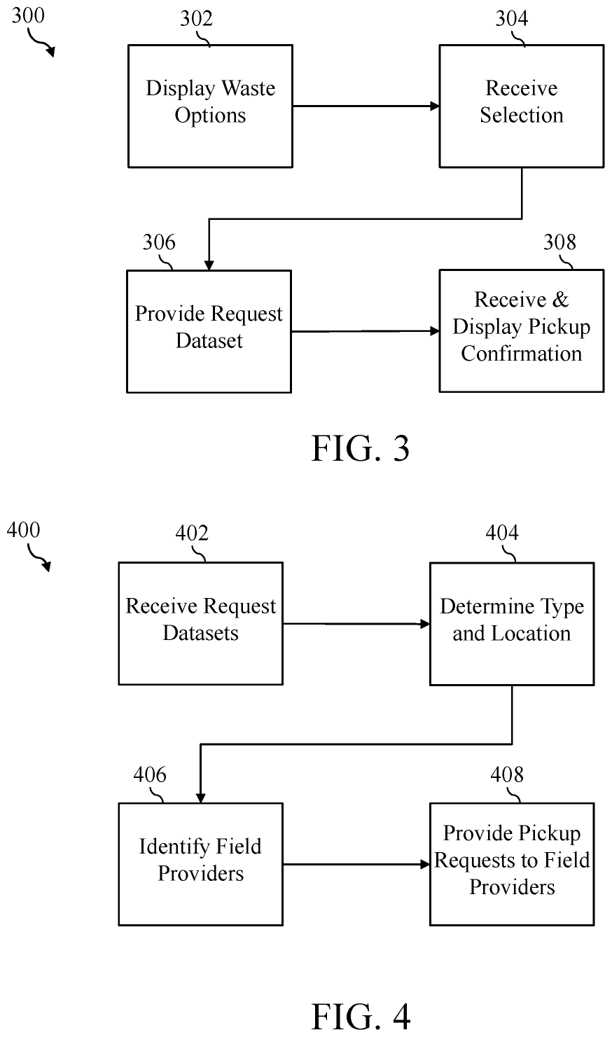

Other variations and features of the system (100) exist beyond those described above. FIGS. 3-6 provide several examples, and other examples will be apparent to those skilled in the art in light of this disclosure. The example of FIG. 3 is a flowchart of an exemplary set of steps (300) that could be performed on the resident device (106) to request a pickup. As one example, the resident device (106) may be a handheld device such as a smartphone or tablet that is configured with a mobile software application that displays information and user controls that a user may interact with in order to register or create an account with the server (102), provide information relating to their location of residence, and provide information describing dates, times, types, and quantities of waste that the user is disposing of.

When submitting a waste pickup request, the resident device (106) may display (302) a number of options and selections relating to the potential waste pickup. Displayed (302) options may include listing the types of waste and other objects that the resident may request for pickup. The available selections may be determined by the server (102) and provided to the resident device (106) and may be based upon the availability of field providers within a geo-mapped area that the resident is within. As an example, a particular resident may register with the server (102) and provide information identifying their location (e.g., street address, zip code, city, etc.), or may provide such information when initiating a request for pickup. Based upon the user's location, the server (102) may query a dataset of field providers to determine a list of field provider's that are available to service that location (e.g., based upon a range of service configured by the field provider, or based upon service zones defined by contractual agreements or other factors). Each available field provider may also be associated with a list of waste types or other objects that are serviced by that field provider. With such information an aggregate list of all waste types and objects that may be picked up in that area may be compiled and displayed (302) as options on the resident device.

Continuing the above example, the resident may view the displayed (302) options and determine that options for pickup include bagged residential waste, bagged yard waste, small chairs, large chairs, small couches, full size mattresses, electronics, bagged aluminum cans, stacked cardboard, and oil-based paints. The resident may have a large couch they wish to dispose of, but field providers servicing that area may not offer that capability and so it may not be present based on the resident's location. The displayed options (302) may also include different types of disposal beyond waste disposal (e.g., landfill disposal), and may include options for selecting appropriate materials for recycling, selecting furniture and electronic equipment for donation instead of disposal, or other disposal options that may offer varying levels of environmental impact, social impact, or other benefits beyond landfill disposal.

Displayed options may also be associated with other information, such as an estimated pickup day, the field providing servicing the request (e.g., a waste management company, a charitable organization), a cost associated with the pickup, and other information. Costs associated with a requested pickup may be determined based upon static rates determined by the type and quantity of waste, or may be dynamically determined on various factors such as the particular field provider, local supply and demand of pickups, the priority of the pickup (e.g., requesting a more immediate or more precise pickup day and time may be associated with a higher cost), and other factors that will be apparent to one skilled in the art in light of this disclosure.

As the resident interacts with the displayed (302) options, selections may be received (304) via the resident device (106) and, once confirmed by the user, provided as a request dataset to the server (102). A request dataset may be processed by the server (102) in order to assign to a field provider and then generate a route that services a plurality of requests, including the particular request, as has been described. At varying times after providing (306) the request dataset, the resident device (106) may receive (308) and display various information and notifications related to the request.

Displayed (308) information may include a notification that the request was accepted by a field provider and an approximate time and day for pickup, a notification that a field operator has begun servicing a route that contains the request, a notification that the request will soon be serviced (e.g., the request may be the next request on the route, or may be estimated to be performed within thirty minutes), a notification that the waste has been picked up, and a notification that the waste has been disposed of (e.g., recyclables have been delivered to a recycling processor, bagged residential waste has been delivered to a landfill, bagged yard waste has been delivered to a composter, donated furniture has been delivered to a charitable organization). Such notifications may include text describing the event, location information (e.g., a location of the vehicle at various times, a location at which the waste was delivered to or disposed at), images showing completion of the pickup request (e.g., a picture of bagged waste loaded into a vehicle after pickup, a picture of a donated couch delivered to a charitable organization), or other information. Such information may be useful for the resident to both ensure that the waste is available to be picked up at the appropriate time during the route, and to ensure that any ecological or social concerns of the customer have been satisfied and that waste, recyclables, or donated objects were not mishandled or disposed of unlawfully.

FIG. 4 is a flowchart of a set of steps (400) that could be performed by the server (102) to distribute pickup requests to a plurality of field providers. A plurality of request datasets may be received by the server (102) over time. As they are received (402), a location of the request (e.g., the location where waste will be placed for pickup) and a quantity and type of waste may be determined (404) so that appropriate field providers may be identified (406), as similarly described in the context of displaying (302) waste options in FIG. 3. In some implementations, a request dataset may not specify a particular field provider and there may be multiple identified (406) appropriate field providers. In such cases, the server (102) may choose from amongst appropriate field providers based upon various static or dynamic factors. As field providers are identified (406) for each type of waste described in the request dataset, the server (102) may provide (408) pickup requests to the appropriate field provider via the field provider interface (108) so that it may be viewed and rejected or confirmed by the field providers system (110).

As an example of the above, a particular request dataset may include a zip code identifying the location of the pickup, and a set of waste descriptors identify three bags of residentials waste for disposal, three bags of recyclables for recycling, and one small couch for disposal. The server (102) may query a geo-mapping dataset to determine a set of field providers that service that zip code, if that has not already been determined at a prior step (e.g., such as when displaying (302) selectable waste options) and associated with the submitted request. The server (102) may then reduce the set of available field providers to only those that service residential waste, recyclables, and small furniture. Where a single field provider is identified (406) as servicing all three waste types from a single vehicle, preference may be given to providing (408) the request to that field provider. Alternately, one or more field providers may be identified (406) based upon contract, load, or other factors. For example, where the small couch is for donation instead of disposal, a first field provider may service the residential waste and recyclables, while a second field provider may pickup the small couch.

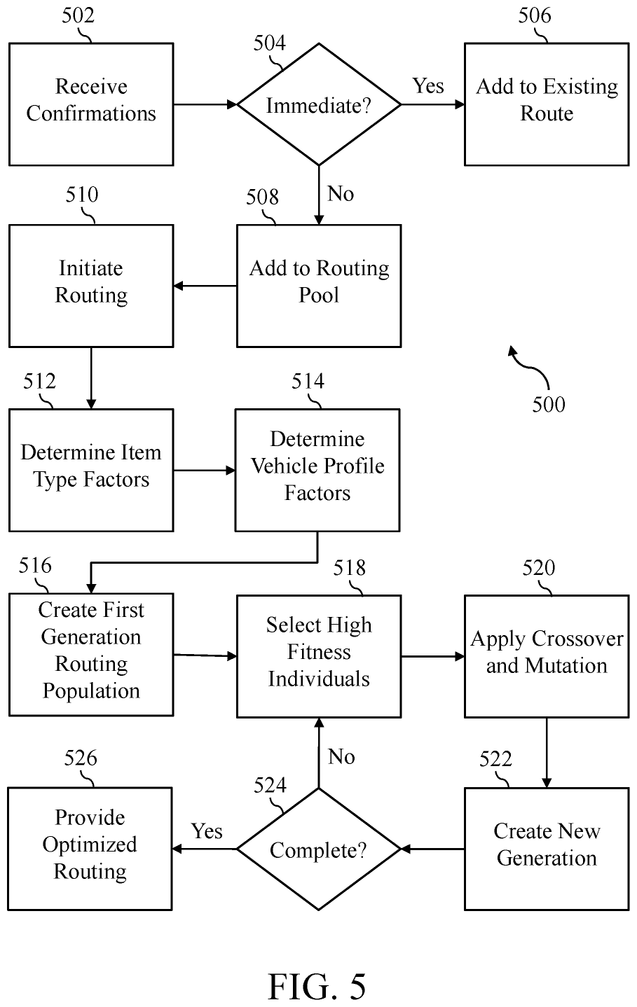

An advantageous aspect of the system (100) is the capability to geo-map requests to appropriate field providers, and then dynamically generate routes that are at least partially optimized and that are usable by field operators to efficiently service requests. FIG. 5 shows an implementation of such a capability as a set of steps (500) that could be performed to create optimized pickup routes for a service provider. As pickup request confirmations are received (502) (e.g., from the field provider system (110) in response to being provided (408) one or more pickup requests), the server (102) may determine if the request can be serviced immediately (504) rather than being held until a new route is generated. This may occur, for example, where there is availability for the request to be added to an existing route without impacting the cost or efficiency of that route beyond a configured threshold. As another example, this may occur even where cost or efficiency is negatively impacted where the request is associated with a high priority or service level, which may be determined based upon factors such as a resident's subscription level, customer service reasons, or acceptance of a higher cost for higher priority pickup.

Where immediate routing is possible or desirable (504), the request may be immediately added (506) to an already existing route that has been generated and associated with a field operator. This may include routes that have been generated but have not yet begun, or may include routes that are currently being performed by a field operator, in which case the field operator may receive updating routing information via the field operator device (114) which includes additional routing for the recently added request. In such cases, the field operator device (114) may provide an indication that the route was updated or incorporate the request silently.

Where a request is not immediately (504) added to an existing queue, the request may instead be added (508) to a routing pool that may contain a plurality of unrouted requests for the field provider. Requests may be retained in the routing pool until routing is initiated (510), which can occur in various circumstances. In some implementations, routing may initiate (510) one or more times per day based upon a preconfigured schedule or based upon a request from the field provider to provide additional routing. In some implementations, routing may automatically initiate (510) in response to the routing pool reaching a certain total number of requests, a previously generated route being completed by a field provider, or other circumstances, as will be apparent to those skilled in the art in light of this disclosure.

When routing is initiated (510), some or all of the contents of the routing pool may be selected and analyzed for routing. For each request, the server (102) may access or determine information relevant to the efficient routing of requests. This may include, for example, determining (512) one or more factors or characteristics relating to the types of items that are associated with pickup by the request, and determining (514) one or more factors or characteristics relating to vehicles in the field providers fleet that are available to service requests.

Item type factors may include information indicating the estimated volume or weight of items associated with the request, whether the items need to be loaded in any particular order relative to other items (e.g., in some cases large items may be placed into a vehicle first, while smaller items may be placed in after), the locations of the items, any particular procedures required for the items (e.g., certain chemical or biological waste may need to be repackaged or specially placed during pickup), and other factors. Generally, factors determined (512) at this stage may influence the relative cost of pickup associated with the item, especially as it relates items associated with other requests in the routing pool, such as the distance between locations of items that are to be picked up and the likelihood that a vehicle may have capacity for two items to be picked up (e.g., some vehicles may be limited to carrying a single king size mattress, and may be used more efficiently if the king size mattress is loaded before other objects.

Determining (514) factors and characteristics of the field providers vehicles may involve creating or accessing a set of vehicle profiles that describe the field provider's fleet. A vehicle profile may include information such as the type of vehicle, a unique identifier (e.g., a VIN, a uniquely assigned software identifier), dimensions of the vehicle (e.g., dimensions of the cargo area, volume of the cargo area), a number of field operators required to field the vehicle (e.g., a driver, an assistant), per-mile and/or per-hour costs, or other cost indicators for fielding the vehicle (e.g., individual or aggregate metrics related to maintenance costs, fuel costs, personnel costs), and other information. Generally, factors determined (514) by the vehicle profile may influence the relative cost of operating the vehicle in the field, especially as it may relate to other vehicles and to pickup requests.

As an example, a vehicle profile for a full-size compacting garbage truck may be associated with a relatively high cost of operation, both per-mile and per-house, as compared to a smaller cargo vehicle. As between the two vehicles, the vehicle profiles may be used to determine which vehicle may be more efficiently routed to a particular pickup request. Where both vehicles are equidistant from the location of a pickup request, the smaller cargo vehicle's profile may indicate a lower relative cost to service the pickup request. Conversely, where the smaller cargo vehicle's profile indicates that servicing the pickup request would completely fill the vehicle's cargo area and require a trip to a landfill or vehicle depot, the vehicle profiles may indicate a lower relative cost of service for the full-size compacting garbage truck to service the pickup request. With a plurality of vehicle profiles and a plurality of pickup requests, it can be seen that generating (208) efficient routing to match multiple pickup requests to vehicles, while considering numerous variables associated with each, is not a trivial task.

One approach to generating efficient routing, that does not rely upon having vast processing power or unconstrained timelines for arriving at a solution, is to apply a genetic algorithm to produce a solution that is at least highly efficient, if not perfectly so. This may include creating (516) a first generation of routing solutions based upon the pickup requests that are being routed. First generation solutions may be created somewhat randomly (e.g., assigning pickup requests to appropriate vehicles semi-randomly and/or based upon very simple comparable metrics such as distance between pickups) with an emphasis on producing a quantity of solutions rather than a small set of efficient solutions. To provide an example, a field provider may have two vehicles of the same type (e.g., the vehicle profiles of each may match or be substantially similar) and may have confirmed ten pickup requests.

When creating a first generation for such an example, the server (102) may assign pickup requests to the vehicle randomly. In some implementations, the server (102) may geo-map the requests and divide them into separate geographical areas (e.g., north/south, east/west) and assign the pickup requests to a vehicle designated for each area (e.g., one vehicle servicing all northern requests, one vehicle servicing all southern requests). In some implementations, the server (102) may determine the two pickup requests that have the maximal distance from each other and from the vehicle origin (e.g., a vehicle depot) and assign each to a separate vehicle, with other pickup requests assigned to each vehicle based upon being the next closest pickup request. Other methods of creating (516) the first generation of solutions exist and will be apparent to those skilled in the art in light of this disclosure.

With a first generation created (516), the server (102) may then select (518) a subset of high-fitness individuals from the first generation based upon an efficiency metric or other threshold. As an example, this may include analyzing each solution from the first generation and determining a fitness score based upon one or more variables such as total distance driven, total route time, unused end-of-route capacity, total cost of operation, and other factors which may, individually or in combination with other data, describe a relative efficiency of a particular solution. This analysis may be performed using an objective function or fitness function, or another function that produces an objective value for the result. Selection of high fitness solutions may also be influenced by other factors, such as formal verification of a formal specification that might exclude some individuals who score highly, but violate some requirement of the formal specification (e.g., an individual that scores highly because it efficiently addresses the great majority of pickups, but includes one pickup that cannot be performed within a required window of time required by the formal specification). By applying such a metric, a solution in which one vehicle completes a route at only half capacity, while the other vehicle is required to stop at a landfill or return to a vehicle depot mid-route may be discarded based upon a low fitness score. Other solutions with poor fitness scores may include those with relatively long total distances or total operation times for one or both vehicles, those in which the vehicles operate in close proximity to each at varying times during the route, those that take one or both vehicle's through high traffic areas, and others.

Once selected (518), the server (102) may apply (520) crossovers and/or mutations to the high fitness solutions in order to create (522) a new generation (e.g., a 2^{nd} generation, 3^{rd} generation, etc.) that will typically be smaller than the prior generation, and will contain more efficient solutions. More efficient solutions are produced by crossover and/or mutation. For example, applying (520) crossover to a generation may include selecting (e.g., randomly or based upon shared or disparate characteristics) two solutions from the generation and blending them together (e.g., by randomly or semi-randomly selecting characteristics from each) into an offspring solution that inherits characteristics from each parent solution. Applying (520) mutation may include randomly modifying one or more characteristics of offspring from crossover, and may prevent the server (102) from inadvertently pursuing an inefficient or stagnant set of solutions by introducing a chance for diversity, since characteristics that may have previously been dropped from the population may be reintroduced and reevaluated.

Once the new generation has been created (522), the new generation may be analyzed using fitness metrics (e.g., such as described in relation to selecting (518) high fitness individuals) and, where any of the solutions fall above a configured threshold for efficiency or fitness, the process may be complete (524) and the most efficient solution may be selected and used. Where no solution from the new generation is deemed efficient, the process is not complete (524) and a new set of high fitness individuals will be selected (518) from the newly created generation, which may then be crossed and mutated (520) to produce (522) a subsequent new generation of offspring, as has been described. These steps may be performed numerous times until a generation is created that contains an offspring solution that is deemed efficient enough to complete (524) the process. Once complete (524), the server (102) may provide (526) the most efficient solution, or a handful of the most efficient solutions, to the field provider system (110) and/or the field operator device (114). Where a handful of solutions are provided to the provider system (110), a desired solution may be selected and distributed to the associated field operator devices.

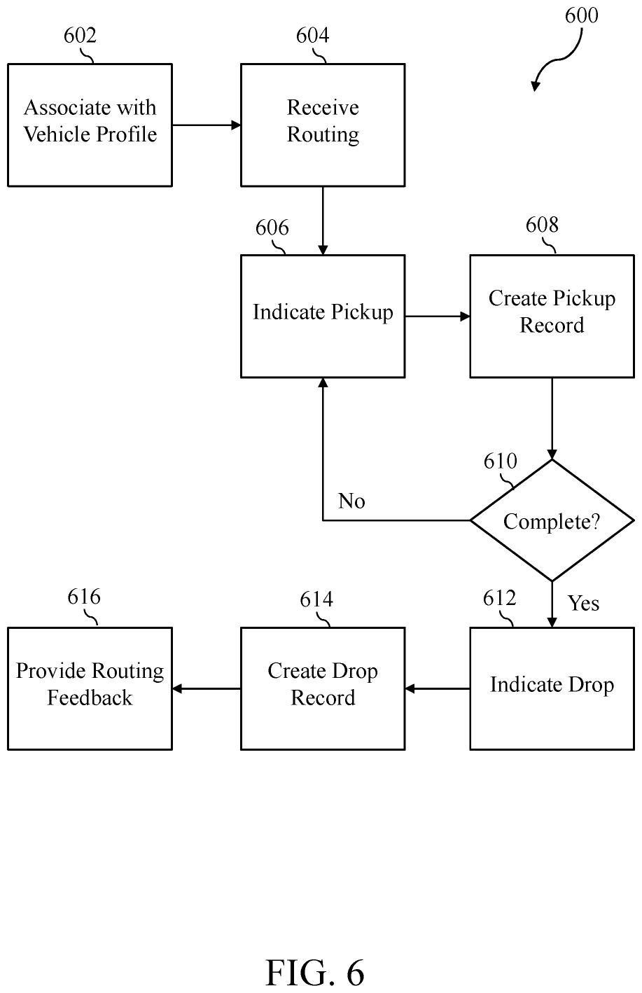

As described above, the server (102) is configured to generate (208) efficient routing for a field provider that may be used to direct one or more field operators to a plurality of pickup locations, in sequence, such that there is a many-to-one correspondence between pickup requests and vehicles. In other words, each field request will be services by exactly one vehicle, and each vehicle may service one or more field requests. Routes may be provided to vehicles via the field operator devices (114). As an example, a field operator device (114) may be a smartphone, tablet, or other handheld device that is associated with a particular vehicle and vehicle profile, and that is configured with a mobile application that is capable of receiving a route and generating turn-by-turn guidance from one pickup location to the next according to the received route. As an example of the above, FIG. 6 shows a set of steps (600) that could be performed by the field operator device (114) to provide route guidance and pickup management.

Initially, a field operator (e.g., a driver, an assistant) may associate (602) the field operator device (114) with a vehicle profile by logging in and/or selecting a vehicle profile from a mobile application running on the field operator device (114). The field operator device (114) may then receive (604) a route associated with that vehicle profile. Once confirmed or initiated, the field operator device (114) may indicate (606) a subsequent pickup location using turn-by-turn directions, an address, or other directional information that may be displayed, spoken, or otherwise indicated or emoted. This may also include the field operator device (114) transmitting information to the server (102) indicating its location relative to one or more subsequent pickup locations, which may be used to notify (210) residents as described in the context of FIG. 2.

Upon arrival at the pickup location, the field operator device (114) may create (608) a pickup record that includes various information and may transmit the pickup record to the server (102). The pickup record may include information such as a time of arrival at the location, departing time, a GPS coordinate or other positional information associated with the location, a manual acknowledgment from a field operator that the appropriate waste or other items were present at the location, an acknowledgment that the waste or other items were taken from the location, images captured (e.g., by a camera of the field operator device (114) or vehicle) at the location before, during, and after pickup, and other information. After the field operator has acknowledged or otherwise indicated that the current pickup has been completed, the field operator device (114) will determine if there are any subsequent pickups or if the route is complete. Where the route is not complete (610), the field operator device will indicate (606) the subsequent pickup location and create (608) a pickup record as has been described.

Where each pickup location along the route has been serviced and the route is complete (610), the field operator device (114) may indicate (612) a drop-off of collected waste and other items. Indicating (612) a drop-off may include displaying turn-by-turn directions and guidance, displaying a destination, or displaying other directional information that may be used to proceed from a current position of the vehicle to a destination, which may be a landfill or other area where collected waste may be dropped off, or may be the vehicle depot from which the vehicle originated, for example. Upon arrival at the drop-off point, the field operator device (114) may create (614) a drop-off record (e.g., similar to the pickup record created (608) previously) to be provided to the server (102). The drop-off record may include information indicating the GPS coordinate or other location information of the vehicle, the time that drop-off began and ended, images of waste and other objects before and after they are removed from the vehicle and disposed of, donated, or otherwise serviced, and other information. The drop-off record may be used by the server (102) to notify (210) residents, as has been described, and may be provided to the field provider system (110) in order to describe the outcome and result of the performance of the route.

The field operator device (114) may also provide (616) routing feedback to the server (102), which may be used to improve the performance of the server's (102) route generation (208), and to update or correct information relating to vehicle profiles, types of waste, and other data objects used by the server (102). Routing feedback may include information that is automatically generated by the field operator device (114) during route servicing, but may also include information that is provided manually by field operators during or upon completion of a route. As an example, where a particular section of a route takes longer than anticipated, or where loading a particular set of waste at a pickup location takes longer than anticipated, such information may be used to automatically adjust the times and/or costs associated with that section of road or that type of waste pickup. As another example, where a particular route includes a toll road that was not anticipated, or a particular object that is picked up does not fit into the vehicle (e.g., such as where a vehicle profile indicates a king size mattress will fit but it does not), a field operator may provide manual feedback indicating the discrepancy.

Provided (616) routing feedback may then be used to update data objects such as vehicle profiles, provider records, resident records, waste and object profiles (e.g., indicating the approximate volume, weight, and dimensions of a bag of residential waste or a piece of furniture), and other information. Provided (616) information may also be used to update and refine the generation (208) of routing. For example, in some implementations feedback may be used to modify the factors associated with item types and vehicle profiles, in order to more accurately reflect the time, effort, cost, or other metric based upon field observations. As another example, the feedback may be used to improve and refine the metrics applied when selecting (518) high fitness individuals, in order to more accurately reflect the value and efficiency of certain characteristics of a solution based upon field observations.

It should be understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

1. A system comprising one or more processors configured to:
(a) receive a plurality of pickup requests from a plurality of resident devices, each pickup request including a location and a pickup description that describes one or more objects to be picked up at that location;
(b) for each of the plurality of pickup requests, identify a field provider from a plurality of field providers based upon the location of the pickup request and a geo-mapping dataset that describes the service areas for each of the plurality of field providers, and provide that pickup request to the field provider;
(c) use an optimization algorithm to generate an optimized route for that field provider based upon a plurality of assigned requests for that field provider, wherein the optimized route describes an order in which a plurality of vehicles that are associated with the field provider will be piloted to the plurality of assigned requests, and describes for each of the plurality of vehicles a plurality of vehicle assigned requests from the plurality of assigned requests; and
(d) provide a vehicle specific route for a vehicle of the plurality of vehicles to a field operator device that is associated with that vehicle, wherein the vehicle specific route is configured to cause the field operator device to provide turn-by-turn directions for piloting the vehicle to each of the plurality of vehicle assigned requests.

2. The system of claim 1, the one or more processors further configured to:
(a) receive the location for a pickup request from a resident device of the plurality of resident devices and determine a set of waste options based on the location, wherein the set of waste options describes types of objects that may be picked up at the location;
(b) provide information to the resident device that is configured to cause the resident device to display the set of waste options; and
(c) receive the pickup description in response to a user of the resident device making selections from the set of waste options.

3. The system of claim 1, the one or more processors further configured to, after providing a pickup request of the plurality of pickup requests to the field provider:
(a) receive a confirmation from the field provider; and
(b) cause a resident device that is associated with the pickup request to display a pickup confirmation based on the confirmation from the field provider, the pickup confirmation indicating a time and a day for completion of the pickup.

4. The system of claim 1, the one or more processors further configured to:
(a) associate each of the plurality of field providers with one or more waste types that may be picked up by those field providers;
(b) determine a set of waste types associated with the one or more objects to be picked up at that location based on the pickup description; and
(c) identify the field provider for that pickup request further based on the set of waste types matching the one or more waste types associated with the field provider.

5. The system of claim 4, wherein the set of waste types includes at least two different waste types and the plurality of field providers includes at least two field providers capable of providing pickup at the location for one or more of the at least two different waste types, and wherein the one or more processors are further configured to identify the field provider for that pickup request from the at least two field providers while giving preference to field providers that can service a greater number of the at least two different waste types.

6. The system of claim 4, wherein the set of waste types includes at least two different waste types, and wherein the one or more processors are further configured to, when identifying the field provider:
(a) identify a first field provider from the plurality of field providers further based upon the first field provider being associated with a first waste type of the at least two different waste types, and provide a first pickup request for the first waste type to the first field provider; and
(b) identify a second field provider from the plurality of field providers further based upon the second field provider being associated with a second waste type of the at least two different waste types, and provide a second pickup request for the second waste type to the second field provider.

7. The system of claim 1, the one or more processors further configured to:
(a) associate each of the plurality of field providers with one or more disposal types that those field providers may provide for the one or more objects to be picked up at that location;
(b) determine a disposal type associated with the one or more objects to be picked up at that location based on the pickup description; and
(c) identify the field provider for that pickup request further based on the disposal type matching the one or more disposal types associated with the field provider, wherein at least one of the plurality of pickup requests is associated with a landfill disposal type and at least one other of the plurality of pickup requests is associated with a donation disposal type.

8. The system of claim 1, wherein the optimization algorithm includes a genetic algorithm configured to produce an improved if not maximally optimal solution for the optimized route, and wherein the one or more processors are further configured to apply a fitness function to evaluate individuals produced by the genetic algorithm based on:
(a) a plurality of item type factors that describe characteristics of a plurality of objects associated with the plurality of assigned requests for that field provider; and
(b) a plurality vehicle type factors that describe characteristics of the plurality of vehicles associated with that field provider.

9. The system of claim 8, wherein the plurality of item type factors describe a set of costs and constraints associated with picking up the plurality of objects, wherein the plurality of vehicle type factors describe a set of costs and capabilities associated with operating the plurality of vehicles, and wherein the fitness function is further configured to give preference to individuals that reduce overall cost of operating the plurality of vehicles to complete the plurality of assigned requests relative to all other individuals in a generation.

10. The system of claim 8, wherein the plurality of item type factors comprise a weight of an object and a volume of the object, and wherein the plurality of vehicle type factors comprise a cargo volume of a vehicle and a per-mile operation cost of the vehicle.

11. The system of claim 1, wherein the one or more processors are further configured to:
(a) receive a set of pickup information from the field operator device during completion of a pickup request associated with the vehicle specific route; and
(b) create a pickup record based on the set of pickup information, wherein the pickup record includes:
(i) a time that the field operator device arrived at the location;
(ii) a GPS location of the field operator device at the time that the field operator device arrived at the location; and
(iii) a time that the field operator device departed the location.

12. The system of claim 1, wherein the one or more processors are further configured to:
(a) receive a set of drop-off information from the field operator device during drop-off of waste from one or more completed pickup requests; and
(b) create a drop record based on the set of drop-off information, wherein the drop-off record includes:
(i) a GPS location of the field operator device at the time that the field operator device arrived at the drop-off location; and
(ii) an image captured via a camera of the field operator device at the drop-off location;
(c) provide a drop-off confirmation to a resident device associated with the one or more completed pickup requests based on the drop record.

13. A method comprising, at one or more processors:
(a) receiving a plurality of pickup requests from a plurality of resident devices, each pickup request including a location and a pickup description that describes one or more objects to be picked up at that location;
(b) for each of the plurality of pickup requests, identifying a field provider from a plurality of field providers based upon the location of the pickup request and a geo-mapping dataset that describes the service areas for each of the plurality of field providers, and providing that pickup request to the field provider;
(c) using an optimization algorithm to generate an optimized route for that field provider based upon a plurality of assigned requests for that field provider, wherein the optimized route describes an order in which a plurality of vehicles that are associated with the field provider will be piloted to the plurality of assigned requests, and describes for each of the plurality of vehicles a plurality of vehicle assigned requests from the plurality of assigned requests; and
(d) providing a vehicle specific route for a vehicle of the plurality of vehicles to a field operator device that is associated with that vehicle, wherein the vehicle specific route is configured to cause the field operator device to provide turn-by-turn directions for piloting the vehicle to each of the plurality of vehicle assigned requests.

14. The method of claim 13, further comprising, at the one or more processors:
(a) receiving the location for a pickup request from a resident device of the plurality of resident devices and determining a set of waste options based on the location, wherein the set of waste options describes types of objects that may be picked up at the location;
(b) providing information to the resident device that is configured to cause the resident device to display the set of waste options; and
(c) receiving the pickup description in response to a user of the resident device making selections from the set of waste options.

15. The method of claim 13, further comprising, at the one or more processors:
(a) associating each of the plurality of field providers with one or more waste types that may be picked up by those field providers;
(b) determining a set of waste types associated with the one or more objects to be picked up at that location based on the pickup description; and
(c) identifying the field provider for that pickup request further based on the set of waste types matching the one or more waste types associated with the field provider.

16. The method of claim 13, further comprising, at the one or more processors:
(a) associating each of the plurality of field providers with one or more disposal types that those field providers may provide for the one or more objects to be picked up at that location;
(b) determining a disposal type associated with the one or more objects to be picked up at that location based on the pickup description; and
(c) identifying the field provider for that pickup request further based on the disposal type matching the one or more disposal types associated with the field provider, wherein at least one of the plurality of pickup requests is associated with a landfill disposal type and at least one other of the plurality of pickup requests is associated with a donation disposal type.

17. The method of claim 13, wherein the optimization algorithm includes a genetic algorithm configured to produce an improved if not maximally optimal solution for the optimized route, the method further comprising, at the one or more processors, applying a fitness function to evaluate individuals produced by the genetic algorithm based on:
(a) a plurality of item type factors that describe characteristics of a plurality of objects associated with the plurality of assigned requests for that field provider; and
(b) a plurality vehicle type factors that describe characteristics of the plurality of vehicles associated with that field provider.

18. The method of claim 13, further comprising, at the one or more processors:
(a) receiving a set of pickup information from the field operator device during completion of a pickup request associated with the vehicle specific route; and
(b) creating a pickup record based on the set of pickup information, wherein the pickup record includes:
(i) a time that the field operator device arrived at the location;
(ii) a GPS location of the field operator device at the time that the field operator device arrived at the location; and
(iii) a time that the field operator device departed the location.

19. The method of claim 13, further comprising, at the one or more processors:
(a) receiving a set of drop-off information from the field operator device during drop-off of waste from one or more completed pickup requests; and
(b) creating a drop record based on the set of drop-off information, wherein the drop-off record includes:
(i) a GPS location of the field operator device at the time that the field operator device arrived at the drop-off location; and
(ii) an image captured via a camera of the field operator device at the drop-off location;
(c) providing a drop-off confirmation to a resident device associated with the one or more completed pickup requests based on the drop record.

20. A system comprising:
(a) a resident device configured to display a set of waste pickup options and receive a user selection identifying a location and one or more objects to be picked up at the location;
(b) a geo-mapping server configured to:
(i) receive a pickup request that is based on the user selection from the resident device, the pickup request including the location and a pickup description that describes the one or more objects to be picked up at the location;
(ii) identify a field provider from a plurality of field providers based upon the location and a geo-mapping dataset that describes the service areas for each of the plurality of field providers, and assign that pickup request to the field provider; and
(iii) use an optimization algorithm to generate an optimized route for that field provider based upon a plurality of assigned requests for that field provider, wherein the optimized route describes an order in which a plurality of vehicles that are associated with the field provider will be piloted to the plurality of assigned requests, and describes for each of the plurality of vehicles a plurality of vehicle assigned requests from the plurality of assigned requests; and
(c) a field operator device configured to:
(i) receive, from the geo-mapping server, a vehicle specific route for a vehicle of the plurality of vehicles that is associated with the field operator device; and
(ii) provide, based on the vehicle specific route, turn-by-turn directions for piloting the vehicle to each of the plurality of vehicle assigned requests.
